(19) United States
(12) Patent Application Publication
(10) Pub. No.: US 2008/0175540 A1
(43) Pub. Date: Jul. 24, 2008

(54) Optical Connector Suitable for Field Assembly

(75) Inventors: Wenxin Zheng, Ellicott City, MD (US); Neal Zumovitch, Franklin, TN (US); Brent Ware, Franklin, TN (US)

Correspondence Address: BANNER & WITCOFF, LTD., 1100 13th STREET, N.W., SUITE 1200, WASHINGTON, DC, 20005-4051, US

(73) Assignee: Tenvera, Inc., Franklin, TN (US)

(21) Appl. No.: 11/836,534

(22) Filed: Aug. 9, 2007

Related U.S. Application Data
(63) Continuation-in-part of application No. 11/624,515, filed on Jan. 18, 2007.

(51) Int. Cl. G02B 6/38

(52) U.S. Cl. 385/60

(57) ABSTRACT

An illustrative optical connector is disclosed having a first component having a first channel therein; a second component having a second channel therein, wherein the second component is configured to physically mate with the first component such that the first and second channels merge to form a single continuous first channel extending completely through the mated first and second components; a third component having a second channel configured to as to receive the mated first and second components; and an optical fiber partially disposed within the second channel. Also disclosed is an illustrative kit having connector components and an illustrative method for combining connector components.

### RELATED APPLICATIONS

This application is a continuation-in-part of, and claims priority to, U.S. patent application Ser. No. 11/624,515, filed Jan. 18, 2007, entitled “Optical Connector Suitable for Field Assembly,” hereby incorporated by reference as to its entirety.

### BACKGROUND

Optical connectors are well known and are available in a variety of configurations. For example, a popular type of optical connector is the SC-type of connector. Other common types of optical connectors are the LC, ST, and FC types. However, most optical connectors require sophisticated equipment to properly and accurately assemble the connectors. Moreover, where optical fiber tips are often angled to reduce reflection at the connection point, rotational alignment is an additional factor that makes the assembling of optical connectors a difficult, delicate, and time-consuming process. Because of this, nearly all optical connectors are pre-assembled at the manufacturer's factory and include a short optical fiber pigtail. The consumer, upon receiving the pre-manufactured connector with pigtail, splices the pigtail to the consumer's own optical fiber, such as by fusion splicing.

There have been several problems with this connectorized pigtail approach. For example, proper splicing of optical fibers requires training and extensive practice. Even after proper training, the splicing process itself is slow, which becomes especially important where a large number of connectors need to be added to an optical system. Additionally, a splice inevitably adds some degree of signal loss, and so with every connector there exists at least two sources of signal loss—at the connector and at the splice. Even with proper training by the person creating the splice, splices (especially mechanical splices, which use an index matching gel that degrades after only a year or two) have proven to be unreliable. Still another problem is that the equipment for creating a relatively good quality splice (i.e., the splicer) is expensive. This expense is magnified where multiple workers operate simultaneously such that each worker requires his or her own splicer.

### SUMMARY

In view of the above, an improved optical connector and process for making an optical connection is needed.

The following presents a simplified summary of illustrative aspects in order to provide a basic understanding of various aspects described herein. This summary is not an extensive overview of the invention. It is not intended to identify key or critical elements of the invention or to delineate the scope of the invention. The following summary merely presents various concepts in a simplified form as a prelude to the more detailed description provided below.

For example, aspects provide an optical connector having a first component having a first channel therein and a first screw thread; a second component having a second channel therein and a second screw thread complementary to and engaged with the first screw thread, wherein the first component is at least partially disposed within the second channel; and an optical fiber partially disposed within the first and second channels.

Further aspects provide, for example, an optical connector having a first component having a first channel therein; a second component having a second channel therein, wherein the second component is configured to physically mate with the first component such that the first and second channels merge to form a single continuous first channel extending completely through the mated first and second components; a third component having a second channel configured to as to receive the mated first and second components; and an optical fiber partially disposed within the second channel.

Further aspects provide, for example, a kit containing various ones of the components that make up the connector, as well as a method for combining the components to create the completed connector.

These and other aspects of the disclosure will be apparent upon consideration of the following detailed description of illustrative aspects.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is a simplified functional representation of a complementary pair of connectors configured to optically mate with each other.

FIG. 2 is a functional representation of the connectors of FIG. 1 in a mated configuration.

FIG. 3 is a top view of various components of an illustrative connector, including an illustrative tube, spring, ferrule holder, spring holder, lock unit, and connector cover.

FIG. 4 is a detail top view of the tube of FIG. 3.

FIG. 5 is a detail side view of the tube of FIG. 3.

FIG. 6 is a detail top view of the spring holder of FIG. 3.

FIG. 7 is a detail top view of the ferrule holder of FIG. 3.

FIG. 8 is a detail first side view of the ferrule holder of FIG. 3.

FIG. 9 is a detail bottom view of the ferrule holder of FIG. 3.

FIG. 10 is a detail second opposing side view of the ferrule holder of FIG. 3.

FIG. 11 is a detail of view 11-11 of the ferrule holder of FIG. 7.

FIG. 12 is a detail of view 12-12 of the ferrule holder of FIG. 7.

FIG. 13 is a detail top view of the lock unit of FIG. 3.

FIG. 14 is a detail side view of the lock unit of FIG. 3.

FIG. 15 is a detail top view of the connector cover of FIG. 3.

FIG. 16 is a detail side view of the connector cover of FIG. 3.

FIG. 17 is a top cross-sectional view of the combined tube and spring of FIG. 3.

FIG. 18 is a top cross-sectional view of the combined tube, spring, and ferrule holder of FIG. 3, which together form an illustrative spring assembly.

FIG. 19 is a top cross-sectional view of the spring assembly of FIG. 18 and the ferrule holder of FIG. 3.

FIG. 20 is a top cross-sectional view of the spring assembly of FIG. 18, and the ferrule holder and lock unit of FIG. 3.

FIG. 21 is a top cross-sectional view of the spring assembly of FIG. 18, and the ferrule holder, lock unit, and connector cover of FIG. 3.

FIG. 22 is a side cross-sectional view of an illustrative ferrule and ferrule tube.

FIG. 23 is a top view of the combined ferrule and ferrule tube of FIG. 22, which together form an illustrative ferrule assembly.

FIG. 24 is a rear cross-sectional view of the ferrule tube of FIG. 22.

FIG. 25 is a rear cross-sectional view of the combined ferrule and ferrule tube of FIG. 23.

FIG. 26 is a perspective view of the ferrule assembly of FIG. 22, the spring assembly of FIG. 18, and an illustrative boot.

FIGS. 27-29 are each a perspective view of the ferrule assembly of FIG. 22 and the ferrule holder of FIG. 3.

FIG. 30 is an alternative configuration of the assembly of FIG. 29.

FIG. 31 is a perspective view of the ferrule assembly of FIG. 22, the ferrule holder of FIG. 3, and the spring assembly of FIG. 18.

FIG. 32 is a perspective view of the assembly of FIG. 31 and further having the lock unit of FIG. 3.

FIG. 33 is a perspective view of the assembly of FIG. 32 and further having the connector cover of FIG. 3.

FIG. 34 is a flow chart showing illustrative steps that may be performed to assemble the assembly shown in FIGS. 21 and 33.

FIG. 35 is a top view of various components of another illustrative connector, including an illustrative optical fiber, spring, ferrule assembly, ferrule holder, lock unit, lock unit cap, boot pipe, and connector cover.

FIG. 36 is a detail top view of a first portion of the ferrule holder of FIG. 35.

FIG. 37 is a detail first side view of the first portion of the ferrule holder of FIG. 35.

FIG. 38 is a detail bottom view of the first portion of the ferrule holder of FIG. 35.

FIG. 39 is a detail second opposing side view of the first portion of the ferrule holder of FIG. 35.

FIG. 40 is a detail top view of a second portion of the ferrule holder of FIG. 35.

FIG. 41 is a detail first side view of the second portion of the ferrule holder of FIG. 35.

FIG. 42 is a detail bottom view of the second portion of the ferrule holder of FIG. 35.

FIG. 43 is a detail second opposing side view of the second portion of the ferrule holder of FIG. 35.

FIG. 44 is a detail end view of the first portion of the ferrule holder of FIG. 35.

FIG. 45 is a detail end view of the second portion of the ferrule holder of FIG. 35.

FIG. 46 is a detail end view of the assembled ferrule holder of FIG. 35.

FIG. 47 is a top view of the ferrule assembly resting in the first portion of the ferrule holder of FIG. 35.

FIG. 48 is a side cross-sectional view of the ferrule assembly disposed inside the completed ferrule holder of FIG. 35.

FIG. 49 is a top cross-sectional view of the lock unit containing the ferrule assembly and ferrule holder of FIG. 48.

FIG. 50 is a detail side view of the lock unit of FIG. 35.

FIG. 51 is a detail top view of the lock unit cap of FIG. 35.

FIG. 52 is a detail first end view of the lock unit cap of FIG. 35.

FIG. 53 is a detail opposing second end view of the lock unit cap of FIG. 35.

FIG. 54 is a detail side view of the combined lock unit, ferrule assembly, ferrule holder, spring, lock unit cap, optical fiber, and boot pipe of FIG. 35.

FIG. 55 is a flow chart showing illustrative steps that may be performed to assemble the assembly shown in FIG. 54.

It is noted that the various drawings are not necessarily to scale.

### DETAILED DESCRIPTION

The various aspects summarized previously may be embodied in various forms. The following description shows by way of illustration various examples in which the aspects may be practiced. It is understood that other examples may be utilized, and that structural and functional modifications may be made, without departing from the scope of the present disclosure.

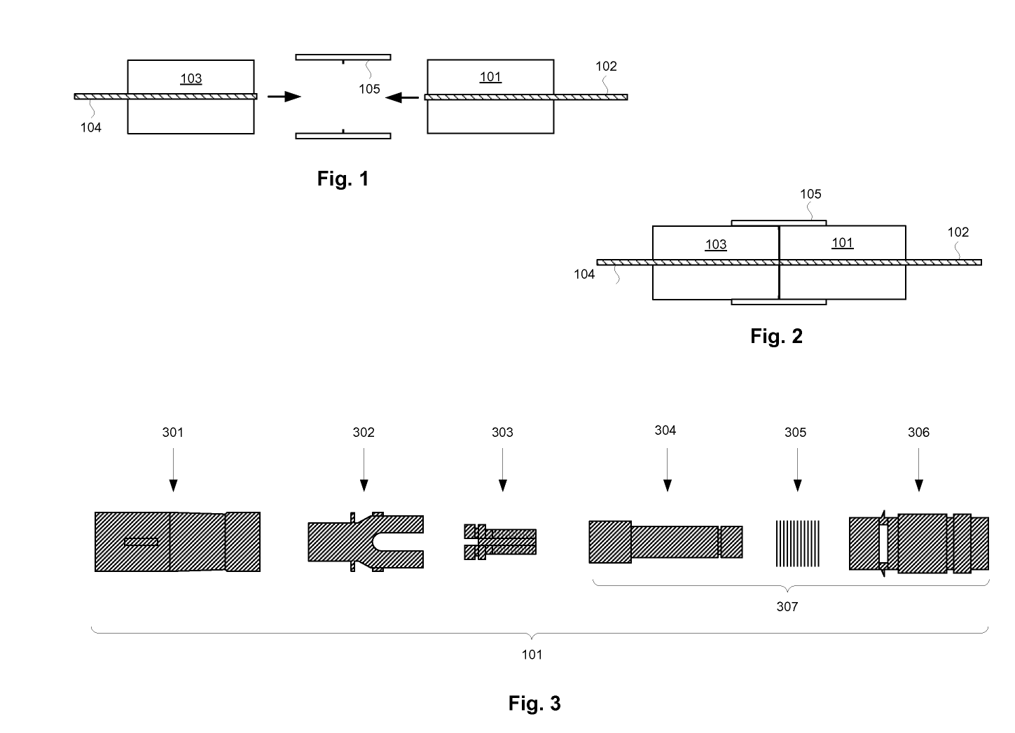

Referring to FIG. 1, a functional diagram shows an illustrative mating pair of optical connectors 101, 103. Each connector 101, 103 has its respective optical pathway for transferring information as modulated light. In the present example, these optical pathways are optical fibers 102, 104. When mated together via an adapter 105 as shown in FIG. 2, the optical pathways are optically coupled together so as to transfer the modulated light from one of the pathways to the other. As illustrated in FIG. 2, when connectors 101 and 103 are properly mated, optical fibers 102 and 104 are brought into contact with each other without an air gap, so as to allow light from one of the optical fibers 102, 104 to transfer into the other one of the optical fibers 102, 104.

The following illustrative embodiments of an optical connector will now be discussed. The connector may be configured so as to be relatively for the end user to easily, quickly, and/or inexpensively add the optical connector to an optical fiber. For instance, the end user may not need a splicer to make the connection, since the connector does not need a pigtail. Thus, the connection may have the potential for contributing less signal loss than do connectorized pigtails, since a splice is no longer needed for each connector. Moreover, the connector may provide for appropriate axial, lateral, and/or rotational alignment of the optical fiber with the optical pathway of the opposing mating connector. Although there exist optical fiber connectors that can be field assembled, these connectors still require fusion splicing or mechanical splicing (with an index-matching gel). In contrast, examples of an optical connector suitable for field assembly will be described in which splicing is unnecessary for creation of the optical connection. Thus, the optical fiber remains intact and may allow for a more reliable and less lossy optical connection. Reliability over a long period of time is important for many applications, especially where the connection may be in a location that is difficult to access after installation, such as within a building wall or underground.

Referring to FIG. 3, a top plan view of a variety of individual components of such an illustrative connector are shown. In this example, connector 101 includes a connector cover 301, a lock unit 302, a ferrule holder 303, a spring holder 304, a spring 305, and a tube 306. When spring holder 304, spring 305, and tube 306 are combined, the resulting combination will be referred to herein as a spring assembly 307. The components are shown in the arrangement in which they are combined in this example. Namely, connector cover 301 is placed over lock unit 302, which in turn is placed over ferrule holder 303 and spring assembly 307. To form spring assembly 307, spring 305 is inserted into tube 306, and spring holder 304 is inserted into spring 305 and tube 306. In addition, ferrule holder 303 is screwed into or otherwise affixed to spring holder 304. The various components 301-307 may be made of any material or combination of materials, such as metal, plastic, and/or ceramic materials.

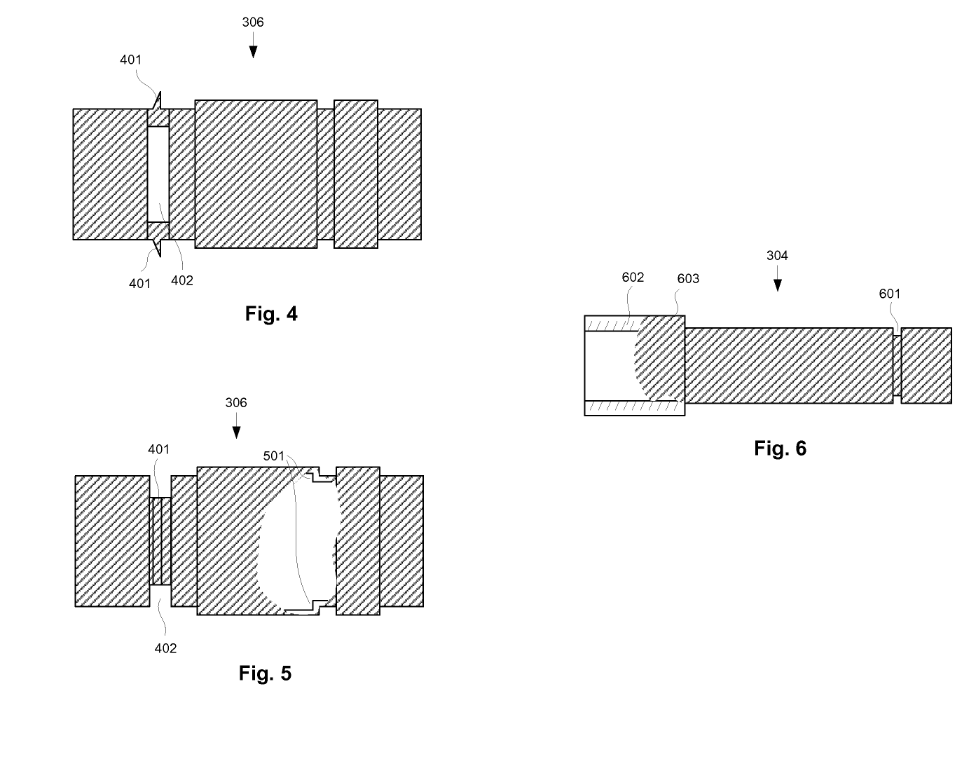

Each of these components 301-307 will be discussed both individually and in conjunction with one another to form an operational connector. FIGS. 4-16 illustrate each component of FIG. 3 in additional detail, with the exception of spring 305. Spring 305 may be a conventional spring. In the shown example, spring 305 is a coiled compression spring, and so a further detailed drawing of spring 305 is unnecessary. However, spring 305 may be another type of spring such as a coiled tension spring or a leaf spring.

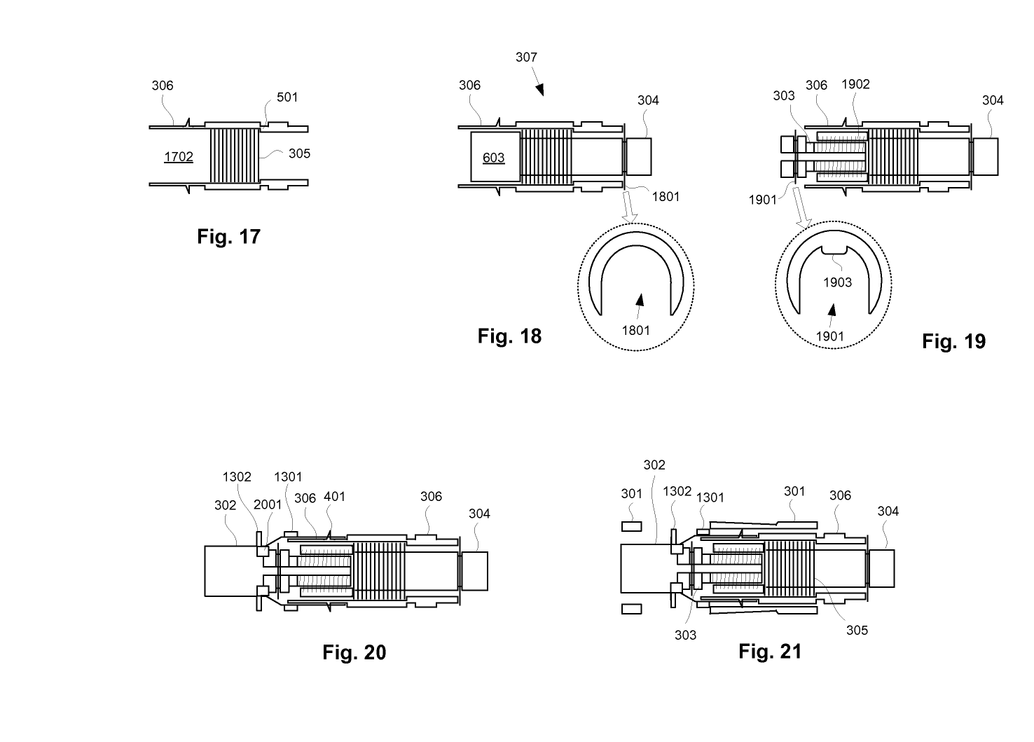

FIGS. 4 and 5 show additional detail of tube 306. FIG. 4 is a top plan view and FIG. 5 is a side view. A purpose of tube 306 is to hold spring 305 and spring holder 304. As shown, tube 306 is generally an elongated hollow cylinder with a hollow enclosed channel 1702 (FIG. 17) extending from end to end along its elongated axis through which optical fiber 102 may be threaded. In addition, tube 306 has a pair of opposed slots 402 and a pair of opposed protruding ears 401. As will be described later, ears 401 are used to affix lock unit 302 to spring assembly 307. In FIG. 5, a portion of the sidewall of tube 306 has been cut away for illustration purposes to expose a portion of the interior of tube 306. As shown, a lip 501 in the form of a step is provided as a stopper against which spring 305 will rest, as will be discussed later. In the present example, lip 501 extends completely around in a circle within an interior portion of tube 306. However, lip 501 may extend only partially around a circle. Also, lip 501 may be embodied as a protruding tab instead of as a step.

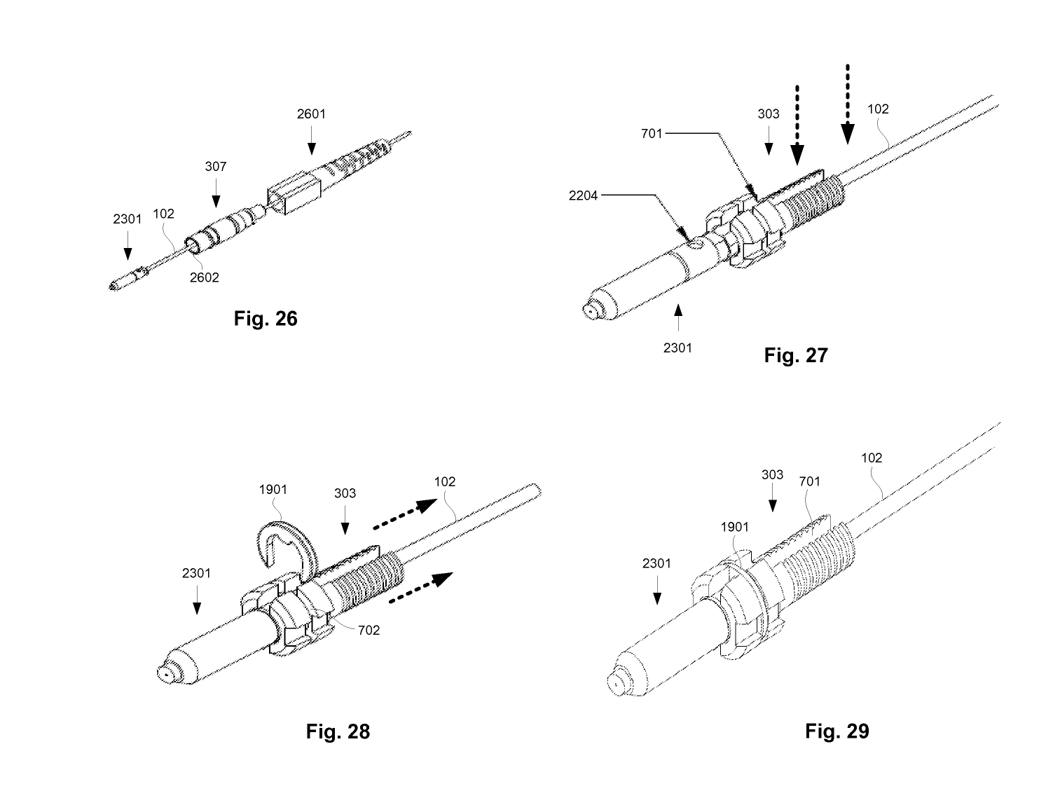

FIG. 6 is a side view of spring holder 304, with a cut-away of a portion showing the interior thereof. As shown, spring holder 304 includes a head portion 603 having a helical interior screw thread 602 for mating with a complementary helical exterior screw thread of ferrule holder 303. Head portion 603 has a larger outer diameter than a remaining portion of spring holder 304. Spring holder 304 has a hollow enclosed channel 2602 (FIG. 26) extending from end to end along its elongated axis through which optical fiber 102 may be threaded. In addition, the exterior of spring holder 304 includes a circular groove 601 thereon for receiving a retaining clip, as will be described later. In the shown embodiment, spring holder 304 is symmetrical about its elongated axis.

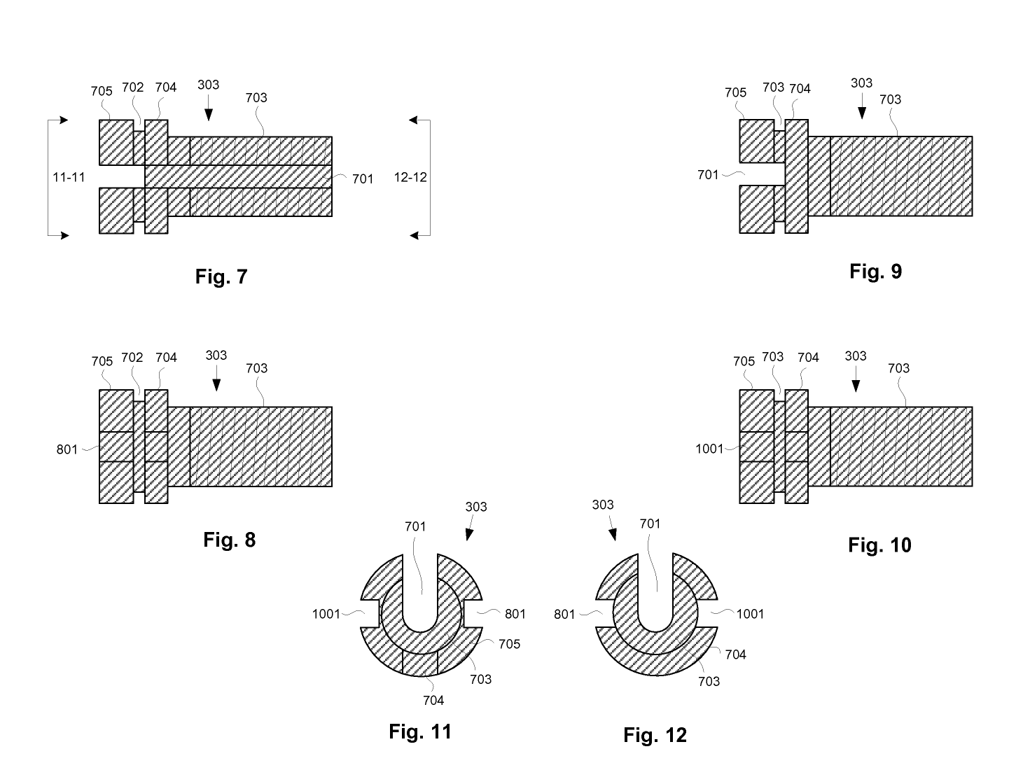

FIGS. 7-12 show various views of ferrule holder 303. In particular, FIG. 7 is a top plan view, FIGS. 8 and 10 are opposing side views, FIG. 9 is a bottom view, FIG. 11 is an end view as indicated by 11-11 in FIG. 7, and FIG. 12 is an opposite end view as indicated by 12-12 in FIG. 7. As shown, ferrule holder 303 is formed as an elongated cylinder having a hollow U-shaped channel 701 that is exposed on one side (in this example, exposed at the top side as shown in FIG. 7). Channel 701 is exposed so that optical fiber 102 may be placed into channel 701 through the exposed side without the need for threading optical fiber 102 lengthwise through channel 701. This is because at least a portion of channel 701 is sufficiently narrow to prevent a ferrule (discussed below) at the end of optical fiber 102 from sliding lengthwise completely through channel 701.

Ferrule holder 303 also has an exterior screw thread 703 that is complementary with and mates to interior screw thread 602 of spring holder 304 by rotating ferrule holder 303 to screw into spring holder 304, in the same manner that a conventional screw is rotated into a nut. Ferrule holder 303 also has a head portion that is made up of an inner flange 704 and an outer flange 705 separated from each other by a circular groove 702. As will be discussed below, groove 702 is configured to receive a retaining clip that affixes the ferrule assembly of optical fiber 102 in all degrees of freedom of motion (e.g., a fixed rotational orientation and longitudinal, i.e., lengthwise, position) relative to ferrule holder 303.

Ferrule holder 303 further includes an opposing pair of notches 801, 1001 in flanges 704 and 705. Notches 801 and 1001 are used to maintain a predetermined rotational alignment of ferrule holder 303 relative to lock unit 302 while still allowing ferrule holder 303 to slide longitudinally in and out of spring assembly 307 against spring 305.

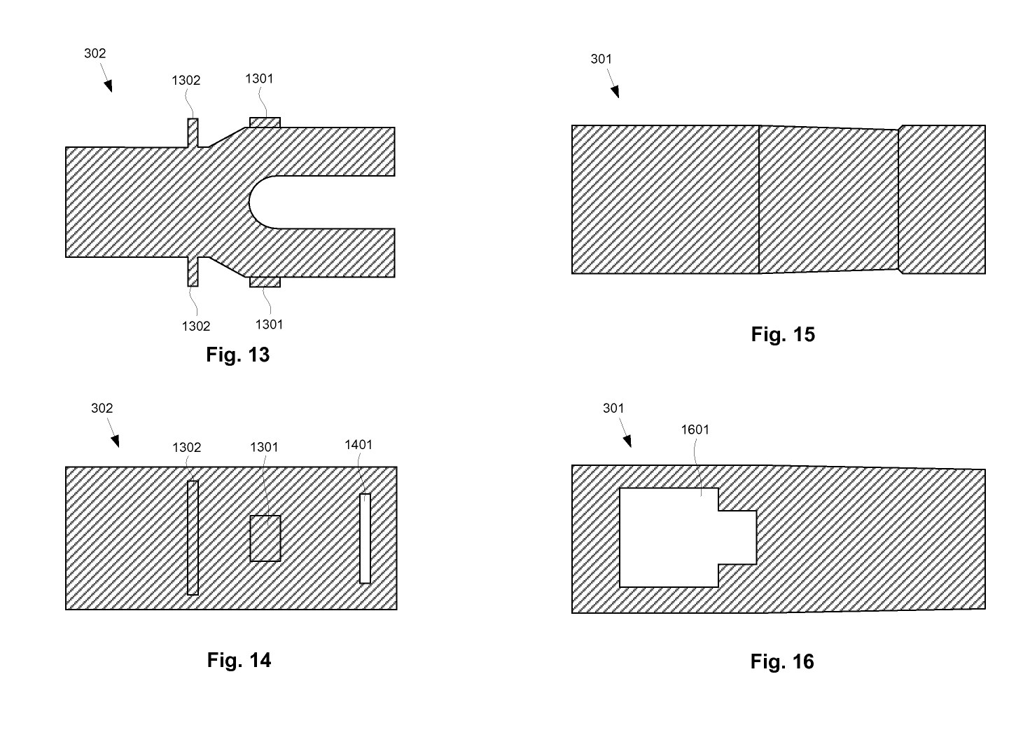

FIGS. 13 and 14 show a top plan view and a side view, respectively, of lock unit 302. As shown, lock unit 302 has a first pair of opposing protruding tabs 1301 and a second pair of opposing protruding tabs 1302. As will be described, tabs 1301 and 1302 are used to affix lock unit 302 to connector cover 301. Lock unit 302 also has a pair of notches 1401 on opposing sides of lock unit 302. These notches 1401 receive ears 401 of tube 306 so as to affix and/or align tube 306 (and thus spring assembly 307) to lock unit 302.

FIGS. 15 and 16 show a top plan view and a side view, respectively, of connector cover 301. As shown, connector cover 301 has a pair of apertures 1601 on opposing sides of lock unit 302. These apertures receive tabs 1301 and 1302 of lock unit 302 so as to affix and/or align lock unit 302 to connector cover 301.

FIGS. 17-21 are top plan views showing various stages of combining the components of connector 101, with selected cut-away details of how certain of the various components fit together. FIG. 17 is a top plan view with a cut-away showing how spring 305 fits within channel 1702 of tube 306. Spring 305 is inserted from the left side aperture of channel 1702 and pushed toward the right until spring 305 rests against lip 501.

Next, referring to FIG. 18, spring holder 304 is inserted from the left side aperture of channel 1702 and pushed toward the right until head portion 603 rests against the left side of spring 305. Thus, spring 305 now encircles the shaft of spring holder 304 between head portion 603 and lip 501. Then, spring holder 304 is pushed further into tube 306 such that spring 305 is under compressive stress, and at that time a retaining clip 1801 is affixed into groove 601 in order to prevent spring holder 304 from slipping out of tube 306 and to maintain the compressive stress. Alternatively, the device could be configured such that when retaining clip 1801 is affixed into groove 601, spring 305 is not under any tension. As shown in the illustrative inset taken from a right-hand point of view in FIG. 18, retaining clip 1801 may be a C-shaped clip that can be slightly stretched open like a spring, which will then snap back to approximately its original shape to fit and remain within groove 601. Alternatively, retaining clip 1801 may hold its current shape such that retaining clip 1801 may be squeezed to fit more tightly within groove 601. In either case, retaining clip 1801 may have an interior radius that is approximately the same as, or slightly larger than, the exterior surface radius of groove 601. Retaining clip 1801 may be made of metal or any other reasonably strong and/or resilient material. The result of connecting these components together results in spring assembly 307, previously referenced.

Next, referring to FIG. 19, ferrule holder 303 is screwed into head portion 603 of spring holder 304. In doing so, exterior screw thread 703 engages with a compatible helical interior screw thread 1902 disposed at the interior surface of head portion 603. As will be discussed later with regard to FIG. 28, another retaining clip 1901 is affixed into groove 702 of ferrule holder 303 to help retain the ferrule assembly of optical fiber 102. Like retaining clip 1801, retaining clip 1901 may be generally C-shaped and made of a material that can be slightly stretched open like a spring, which will then snap back to approximately its original shape to fit and remain within groove 1901. Alternatively, retaining clip 1901 may retain its current shape and may be squeezed to as to fit more tightly within groove 1901. In either case, retaining clip 1901 may have an interior radius that is approximately the same as, or slightly larger than, the exterior surface radius of groove 701. In addition, as will be discussed further with regard to FIG. 28, retaining clip 1901 may have a tab 1903 or other protrusion that couples with a complementary depression in the ferrule assembly of optical fiber 102, to help retain rotational orientation of the ferrule assembly.

Next, referring to FIG. 20, spring assembly 307 plus ferrule holder 303 is inserted into lock unit 302. As previously described, each of ears 401 of tube 306 fit into respective opposing notches 1401 of lock unit 302 to affix lock unit 302 and spring assembly 307 together. In addition, lock unit 302 includes a pair of opposing tabs 2001 on its interior surface that fit into notches 801 and 1001, respectively, of ferrule holder 303. This helps to ensure a fixed rotational orientation of ferrule holder 303 with respect to lock unit 302.

Next, referring to FIG. 21, the entire assembly of FIG. 20 is inserted into connector cover 301. As previously described, tabs 1301 and 1302 of lock unit 302 fit into respective opposing apertures 1601 to help affix lock unit 302 to connector cover 301. Thus, FIG. 21 shows illustrative completed connector 101, except for optical fiber 102 and its ferrule assembly.

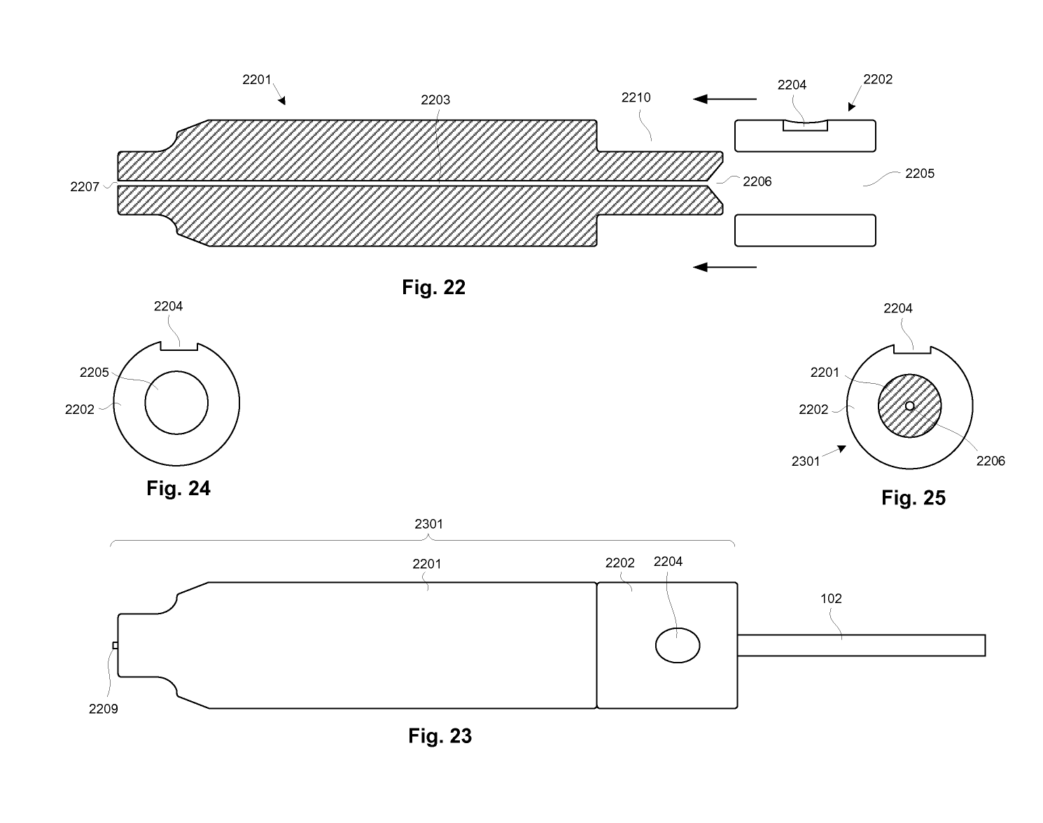

FIG. 22 shows a side cross-sectional view of an illustrative ferrule 2201 and ferrule tube 2202 that together make up the ferrule assembly of optical fiber 102. Ferrule 2201 has a generally elongated shape and has a hollow channel 2203 extending completely through ferrule 2201 along its lengthwise axis from a first aperture 2206 to a second opposite aperture 2207. Channel 2203 is configured such that optical fiber 102 may be threaded through channel 2203 (albeit it may be a stripped version of optical fiber 102, i.e., stripped of its protective covering, that passes through channel 2203). In passing optical fiber 102 through channel 2203, a glue or other adhesive may be added to the interior surface of channel 2203 and/or the exterior surface of optical fiber 102 to affix optical fiber 102 to ferrule 2201.

Ferrule 2201 further has a narrower portion 2210 for receiving ferrule tube 2202. This narrower portion 2210 is configured such that when put together, ferrule 2201 and ferrule tube 2202 form a single approximately flush exterior cylindrical surface, as shown in FIG. 23. Together, ferrule 2201 and ferrule tube 2202 form a ferrule assembly 2301. As further shown in FIGS. 22, 24 and 25, ferrule tube 2202 has a hollow aperture 2205 for receiving narrower portion 2210 of ferrule 2201. In addition, ferrule tube 2202 has a notch, hole, or other depression 2204 for receiving tab 1903 of retaining clip 1901. A glue or other adhesive may be applied on the surface of narrower portion 2210 and/or the interior surface of channel 2205 to affix ferrule 2201 and ferrule 2202 together.

After optical fiber 102 is affixed to ferrule assembly 2301, the tip 2209 of optical fiber 102 is cut and polished as in conventional ferrule assemblies. In addition, tip 2209 may be cut at an angle to the lengthwise axis of optical fiber 102 and ferrule assembly 2301, so as to reduce potential signal reflection. Such angular tips are known in the art. The rotational orientation of the angled surface of tip 2209 about the longitudinal axis of optical fiber 102 may be set at a particular orientation depending upon the rotational position of depression 2204. Put another way, depression 2204 may be used as a point of reference for cutting the angled surface of tip 2209.

Ferrule tube 2202 and ferrule 2201 may be made of the same materials or of different materials than each other. For instance, ferrule 2201 may be made of a ceramic or plastic, while ferrule tube 2202 may be made of a metal. Where ferrule 2201 is made of ceramic, it may be easier to control precise dimensions, such as concentricity, than where ferrule 2201 is made of metal or other materials. It is expected, for instance, that manufacturing a ceramic ferrule 2201 versus a metal ferrule 2201 may result in as much as a ten-fold reduction in fiber-to-ferrule concentricity errors. Such a reduction in concentricity errors, in turn, is expected to reduce connection losses considerably, especially where connector 101 is connected to a standard SC-type connector or other connector where optical fiber 102 must precisely align with optical fiber 104.

As previously mentioned, when depression 2204 receives tab 1903, this allows ferrule assembly 2301 (and thus optical fiber 201) to be fixed in a particular rotational orientation relative to ferrule holder 303 (and indeed to the entire connector 101, since ferrule holder 303 is rotationally fixed relative to spring assembly 307, lock unit 302, and connector cover 301).

In practice, spring assembly 307 may already be pre-assembled by the time it reaches the end user. Thus, the end user may need only to attach ferrule holder 303, retaining clip 1901, lock unit 302, connector cover 301, optical fiber 102, and ferrule assembly 2301 together to form connector 101. In such a case, a kit may be sold or otherwise provided that includes at least one of each of the following components: spring assembly 307, ferrule holder 303, retaining clip 1901, lock unit 302, and connector cover 301, ferrule 2201, and ferrule tube 2202. However, other kits may provide any sub-combination of these items (i.e., leave out one or more of these listed items). The kit may also include written instructions for assembling connector 101 from the included components.

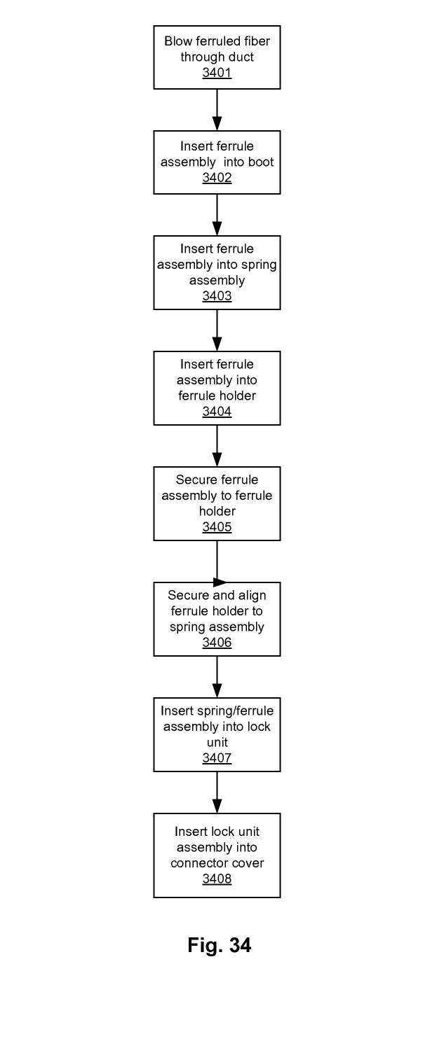

An illustrative method for assembling connector 101 from provided spring assembly 307 is now described in connection with the perspective views of FIGS. 26-33 and the flow chart of FIG. 34. This method may also be described, in whole or in part, by the written instructions in the above-mentioned kit.

First, ferrule assembly 2301 is created and added to optical fiber 102 as previously described in connection with FIGS. 22-25. Next, optical fiber 102 with ferrule assembly 2301 may be blown with an air gun and/or pushed through a duct, such as a narrow conduit (step 3401). Examples of how a ferruled optical fiber may be blown in this manner are described in U.S. patent application Ser. No. 11/551,098, filed Oct. 19, 2006, which is incorporated by reference herein as to its entirety. Alternatively, ferrule assembly 2301 may be created and added to optical fiber 102 after placement of optical fiber 102 in a duct, cable tray, or other desired location.

Next, referring to FIGS. 26 and 34, ferrule assembly 2301 is threaded through a flexible boot 2601 (step 3402). Boot 2601 may be made of any material, such as rubber or plastic, and helps to spread out bending stresses imposed on optical fiber 102 to avoid damage to optical fiber 102. Next, ferrule assembly 2301 is threaded through spring assembly 307 (step 3403). FIG. 26 thus shows the state of assembly after steps 3402 and 3403 have been performed.

Next, ferrule assembly 2301 is inserted into ferrule holder 303 (step 3404), as shown in FIG. 27. To do this, optical fiber 102 is slid laterally into channel 701 in the direction of the broken arrows in FIG. 27. Then, optical fiber 102 is pulled in a backward direction (as indicated by the broken arrows in FIG. 28), and/or ferrule assembly 2301 is pushed in that direction, such that ferrule assembly 2301 seats into ferrule holder 303 as shown in FIG. 28. At this point, depression 2204 of ferrule assembly 2301 should face toward the aperture of channel 701 to receive tab 1903 of retaining clip 1901. Thus, as shown in FIG. 29, retaining clip 1901 is stretched to fit around groove 702 of ferrule holder 303 and to insert tab 1903 into depression 2204. The fitting of tab 1903 into depression 2204 helps to affix ferrule assembly 2301 to ferrule holder 303 (step 3405), by substantially reducing or even preventing forward/backward motion and rotational motion of ferrule assembly 2301 relative to ferrule holder 303.

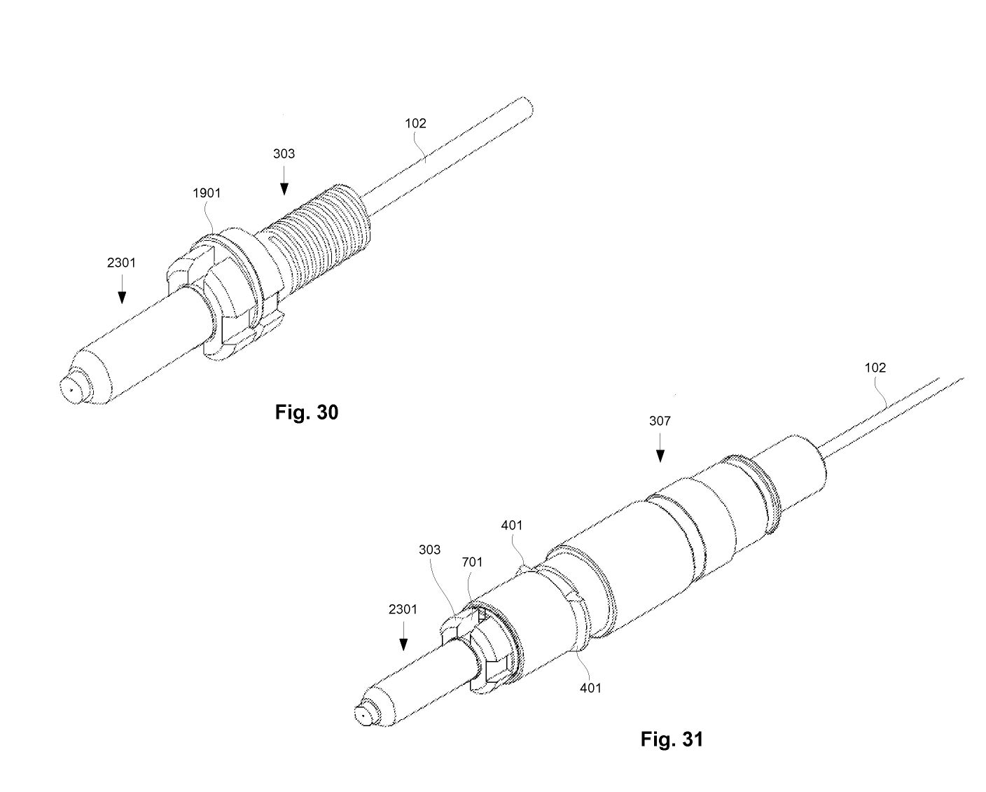

As shown in FIGS. 27-29, depression 2204 and tab 1903 are both rotationally aligned with the open side of channel 701 of ferrule holder 303. However, alternatively depression 2204 and tab 1901 may be rotationally aligned at a point that is 180 degrees opposite the open side of channel 701, such as shown in FIG. 30. This may allow optical fiber 102 to be slid laterally into channel 701 after retainer clip 1901 is already placed around groove 702, since the open end of C-shaped retainer clip 1901 may be aligned with the open end of channel 701. Thus, optical fiber 102 may be slid laterally into channel 701 while passing through the open end of retainer clip 1901. This may further allow ferrule holder 303 to already have retainer clip 1901 loosely disposed in groove 702 when it is provided to the end user, thereby reducing the number of steps needed to be taken by the end user. In such a case, the end user need only squeeze retainer clip 1901 more tightly into groove 702 in order to engage tab 1903 with depression 2204.

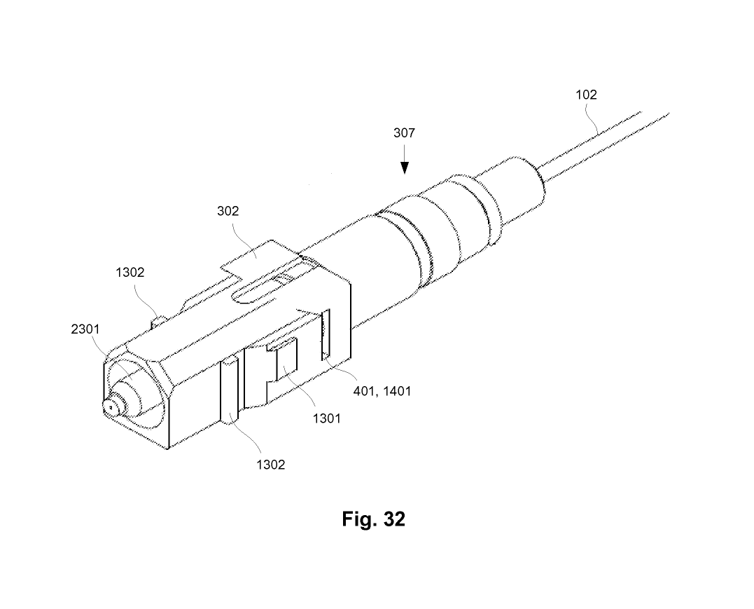

Regardless of whether the assembly of FIG. 29 or FIG. 30 is produced, ferrule holder 303 and spring assembly 307 are next screwed together using complementary screw threads 602 and 703, as shown in FIGS. 31 and 34 (step 3406). In addition, ferrule holder 303 and spring holder 304 are rotated together within tube 306 such that the open side of channel 701 faces orthogonally from ears 401, as shown in FIG. 31. This will allow for ears 401 of tube 306 to properly fit within respective notches 1401 of lock unit 302, while also allowing for tabs 2001 of lock unit 302 to fit within respective notches 801, 1001 of ferrule holder 303 (step 3407), as shown in FIGS. 20 and 32.

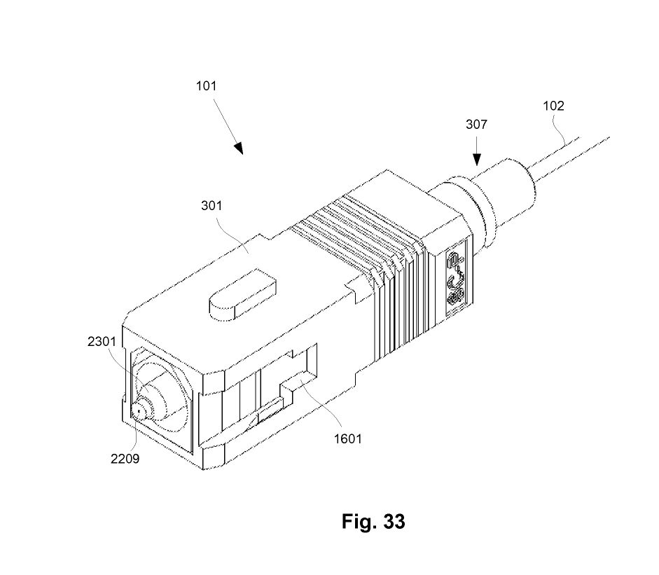

Next, the lock unit assembly of FIG. 32 is inserted into connector cover 301, as shown in FIG. 33 (step 3408). When properly fitted in this example, tabs 1301 and 1302 of lock unit 302 fit in respective opposing apertures 1601 of connector cover 301. Upon completion of this step, illustrative connector 101 has successfully been created and is ready for plugging in to another connector.

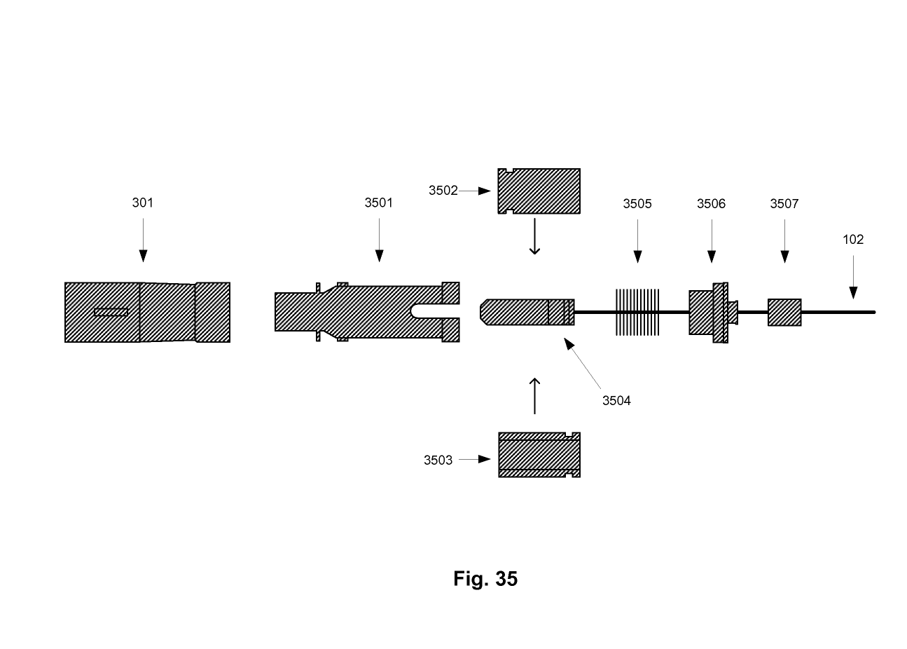

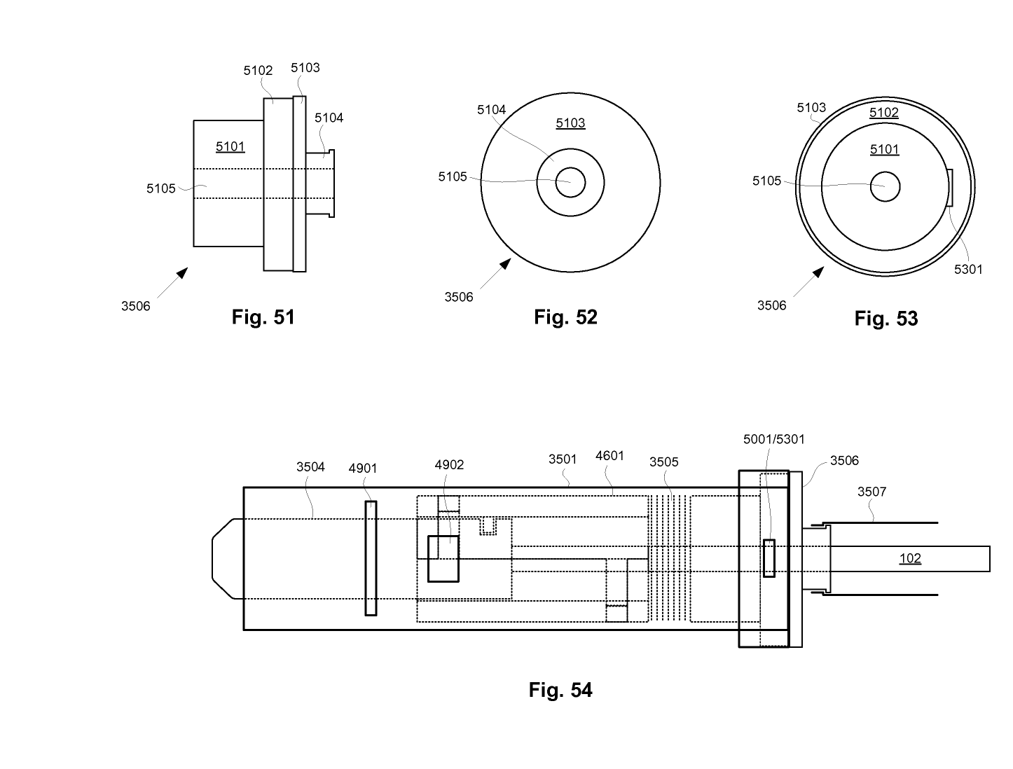

FIGS. 35-53 show another example of an optical connector and method for assembly. In this example, the optical connector may also be an SC-P type optical connector or any other type of optical connector, and may be made completely or mostly of, for instance, plastic or another moldable material. In addition, the optical connector may be assembled in the field without the need for any assembly tools, as the parts may be configured to simply snap together.

Referring to FIG. 35, the optical connector may include connector cover 301 (which may be the same as connector cover 301 of FIG. 3), a lock unit 3501 (which may be the same as or different from lock unit 302 of FIG. 3), a ferrule holder having portions 3502 and 3503 (and which is different from ferrule holder 303), a spring 3505, a lock unit cap 3506, and a boot tube 3507. Also, a ferrule assembly 3504 may be provided to fit within the ferrule holder. Ferrule assembly 3504 may be the same as or different from ferrule assembly 2301. Each of these elements are described below in further detail both individually and in the manner in which they may fit together to form the optical connector.

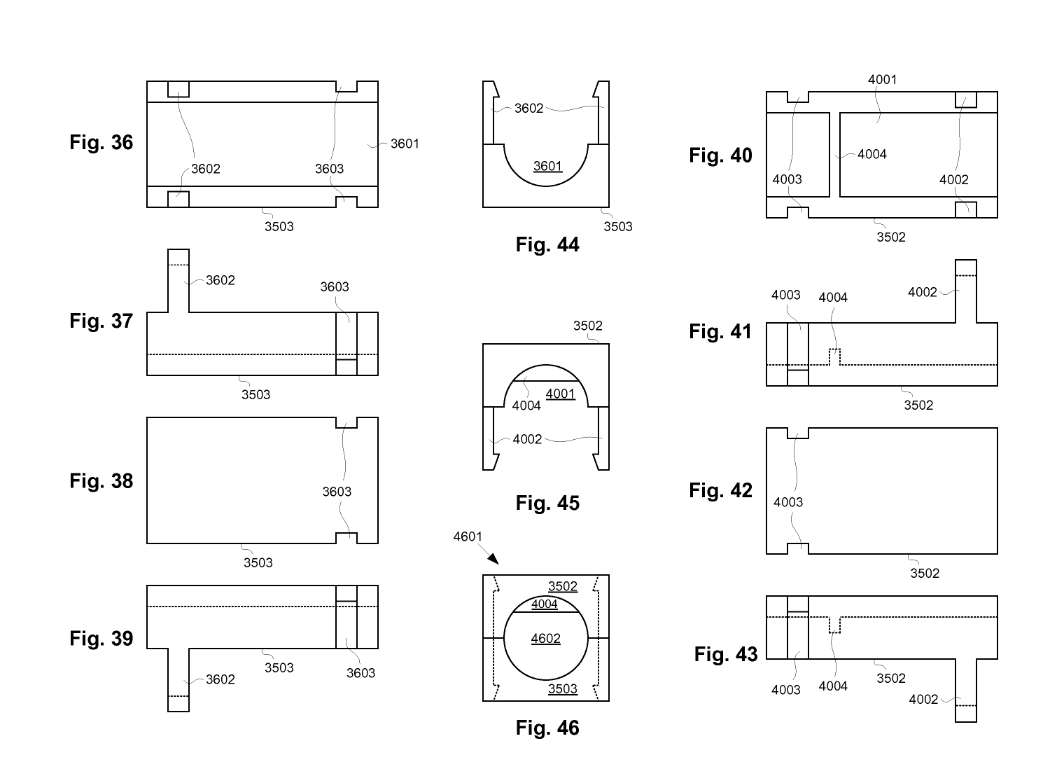

As can be seen in FIG. 35, ferrule holder portions 3502 and 3503 may be provided as two physically separate portions that which may be physically connected together (e.g., snapped together) to form a single ferrule holder that encloses ferrule assembly 3504. However, portions 3502 and 3503 may not be physically separate, and may instead, for example, be connected on a single side in a clam shell configuration so that they pivot between an open position and a closed position. FIGS. 36-39 and 44 show additional details of portion 3503, FIGS. 40-43 and 45 show additional details of portion 3502, and FIG. 46 shows portions 3502 and 3503 connected together as a completed ferrule holder 4601. In this example, portions 3502 and 3503 are configured differently from each other, however they may be identical and/or mirror images of each other.

As shown in the present example, portion 3503 defines a hollow semi-circular channel 3601, and portion 3502 defines an opposing hollow semi-circular channel 4001. When portions 3502 and 3503 are connected together, open channels (e.g., U channels) 3501 and 4001 together form a single enclosed (e.g., circular) channel 4602 that extends longitudinally completely through ferrule holder 4601 and into which ferrule assembly 3504 may fit. In addition, each portion 3502, 3503 may have respective pins 3062, 4002 that fit/snap into respective slots 3603, 4003 of the opposing portion in order to affix portions 3502 and 3503 together without falling apart.

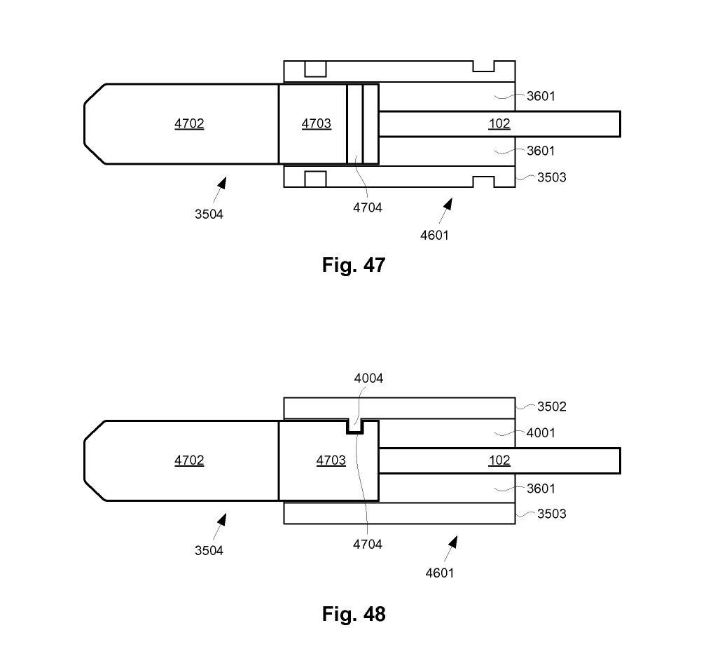

In addition, portion 3502 and/or portion 3503 may be configured to mate with a physical feature of ferrule assembly 3504 when ferrule assembly 3504 is in a particular rotational orientation with respect to ferrule holder 4601. For example, ferrule assembly 3504 may have a depression or protrusion, and ferrule holder 4601 may have a corresponding protrusion or depression that physically mates with the depression or protrusion of ferrule assembly 3504. Referring to a more concrete example, portion 3502 may have a protrusion 4004 in the wall of channel 4001 that physically mates with a notch 4604 of ferrule assembly 3504. This is also shown in the top and side views, respectively, of FIGS. 47 and 48. Such orientation-dependent fitting together may help maintain a predetermined rotational orientation of ferrule assembly 3504 with respect to ferrule holder 4601. Thus, notch 4604 may serve substantially the same function as depression 2204 of FIGS. 22 and 23.

In another example that applies to all embodiments described herein, ferrule assembly 3504 and ferrule holder 4601 may not have specific depressions or protrusions, and instead may be shaped so as to mate in only one or two possible orientations. For instance, ferrule assembly 3504 may have an outer shape as a cylindrical trapezoid, and channel 4602 of ferrule holder 4601 may have a corresponding inner trapezoidal shape (i.e., elongated and with a trapezoidal cross sectional) such that channel 4602 will receive ferrule assembly 3504 only in a certain predetermined relative rotational orientation. Or, ferrule assembly 3504 may have an outer shape as a cylindrical oval, and channel 4602 may have a corresponding internal oval shape such that channel 4602 will receive ferrule assembly 3504 only in two predetermined relative rotational orientations.

As also shown in FIGS. 47 and 48, ferrule assembly 3504 may include a ferrule 4702 and a ferrule tube 4703, each of which may be configured and manufactured in the same manner as ferrule 2201 and ferrule tube 2202, respectively. For instance, ferrule 4702 and ferrule tube 4703 may be made of the same material as each other or different materials from each other, such as a ceramic ferrule 4702 and a metal ferrule tube, respectively. Alternatively, ferrule assembly 3504 may be a single continuous unit rather than a separate ferrule 4702 and ferrule tube 4703.

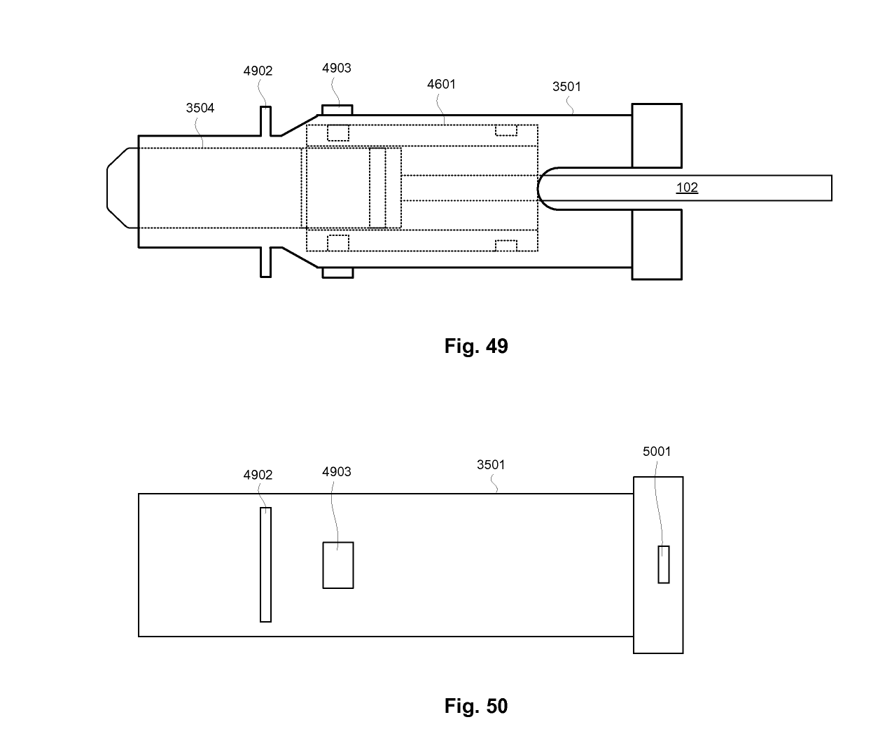

FIG. 49 shows a top view of ferrule assembly 3504 and ferrule holder 4601 disposed in lock unit 3501, and FIG. 50 shows a side view of lock unit 3501. The exterior shape of ferrule holder 4601 and the inner shape of lock unit 3501 may be shaped so as to allow only one or two predetermined relative orientations between them while ferrule holder 4601 is properly disposed within lock unit 3501.

Like lock unit 302, lock unit 3501 may include one or more physical features for connecting to connector cover 301. In this example, lock unit 3501 has two pairs of protruding tabs 4902 and 4903 as shown, that physically mate with (e.g., snap into) apertures 1601 of connector cover 301 so as to affix lock unit 3501 with connector cover 301 longitudinally and in a predetermined relative rotational orientation. Lock unit 3501 may further have an aperture 5001 for receiving a protruding tab 5301 (FIG. 53) of lock unit cap 3506 so that lock unit cap 3506 remains affixed to lock unit 3501.

Referring to FIGS. 51-53, lock unit cap 3506 may include a body having a channel 5105 extending completely through the body so as to allow for optical fiber 102 to pass fully through lock unit cap 3506. The body may include one or more portions, such as an inner portion 5101 sized and shaped so as to fit within lock unit 3501, a middle portion sized and shaped also so as to fit within lock unit 3501, an outer portion 5103 sized and shaped so as not to fit within lock unit 3501, and/or a boot pipe receiving portion 5104 sized and shaped so as to snugly fit into or around boot pipe 3507. Lock unit cap 3506 may also include protruding tab 5301, which, as previously described, is sized and shaped so as to fit within aperture 5001 of lock unit 3501.

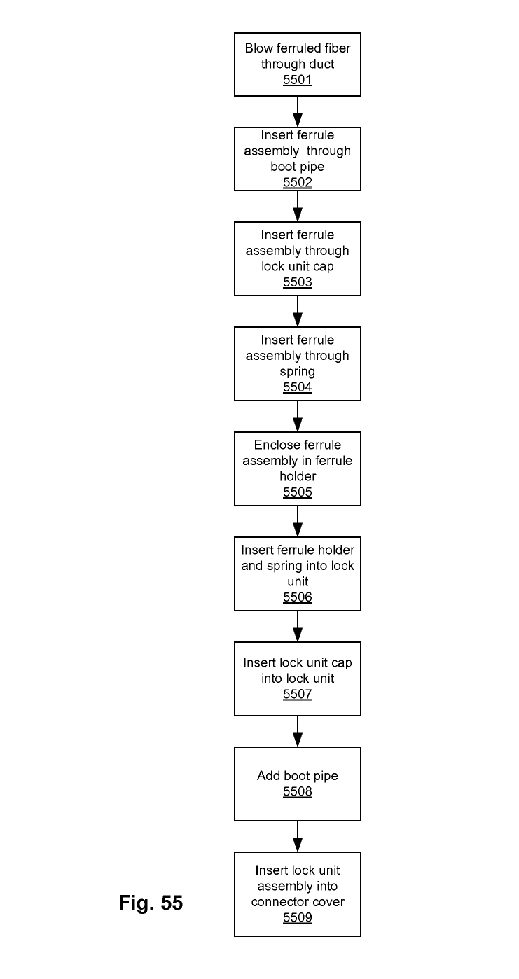

Referring to FIGS. 54 and 55, this illustrative optical connector may be assembled in the field, for example, as follows. First, optical fiber 102, which already includes ferrule assembly 3504 attached to optical fiber 102 by the manufacturer, may be blown with an air gun and/or pushed through a duct, such as a narrow conduit (step 5501). As mentioned previously, examples of how a ferruled optical fiber may be blown in this manner are described in U.S. patent application Ser. No. 11/551,098, filed Oct. 19, 2006. Alternatively, ferrule assembly 3504 may be created and added to optical fiber 102 after placement of optical fiber 102 in a duct, cable tray, or other desired location.

Next, ferrule assembly 3504 and optical fiber 102 are threaded through boot pipe 3507 (step 5502). Boot pipe 3507 may be made of any flexible or inflexible material, such as but not limited to rubber, plastic, or metal. Boot pipe 3507 may be heat-shrink tubing that shrinks in response to applied heat. Next, ferrule assembly 3504 and optical fiber 102 are threaded through channel 5105 of lock unit cap 3506 (step 5503).

Next, ferrule assembly 3504 and optical fiber 102 are threaded through spring 3505 (step 5504). Then, ferrule assembly 3504 is enclosed within ferrule holder 4601 by mating portions 3502 and 3503 together to surround ferrule holder 4601 such that optical fiber 102 extends out of one end of channel 4602 and the tip of ferrule assembly 3504 extends out of the other opposing end of channel 4602 (step 5505).

Then, ferrule holder 4601 and spring 3505 are inserted into lock unit 3501 (step 5506), spring, lock unit cap 3506 is at least partially inserted into (e.g., snapped together with) lock unit 3501 (step 5507), such that channel 4602, the hollow channel of lock unit 3501, and channel 5105 are co-axial. Then, boot pipe 5507 is connected to boot pipe receiving portion 5104 of lock unit cap 3506 (step 5508). If boot pipe 5507 is heat-shrink tubing, then heat may be applied at this point to shrink boot pipe 5507 to closely hug optical fiber 102 and boot pipe receiving portion 5104.

The assembly as provided thus far by steps 5501 to 5508 is shown in FIG. 54. As can be seen, ferrule assembly 3504, spring 3505, lock unit 3501, lock unit cap 3506, boot pipe 3507, and optical fiber 102 are configured relative to each other as shown. Because each piece within the optical connector may only fit with another piece in a single rotational orientation (or possibly two rotational orientations), there is a known rotational orientation relationship between optical fiber 102 and to lock unit 3501. When lock unit cap 3605 is inserted into lock unit 3501, inner portion 5101 of lock unit cap 3605 may apply pressure against spring 3505, and ferrule holder 4601 may resist the pressure, thereby partially compressing spring 3505. However, spring 3505 does not necessarily need to be partially compressed in the final assembly. Either way, spring 3505 may serve to absorb pressure applied to the tip of ferrule assembly 3504 when connecting the optical connector to another optical connector. Once the assembly of FIG. 54 is created, lock unit 3501 may be inserted into (e.g., snapped together with) connector cover 301 as previously described (step 5509), such that all of the channels of all of the components 301, 3501, 4601 and 3506 are co-axial, thereby producing the completed optical connector.

Assembly of the optical connector such as described with regard to FIG. 55 may be easily performed in the field without the need for any tools. In this example, each component may simply snap together using only a technician's bare hands. Also, because most if not all of the components (e.g., 301, 3501, 3502, 3503, and/or 3505) may be manufactured using a molding process, a relatively high consistency in product quality may be easily achieved. Moreover, the molding of such parts may allow for inexpensive large-scale manufacturing, thereby resulting in low unit cost. In addition, in all of the illustrative field-assembled optical connectors described herein, no index-matching gel is needed, and thus the optical connection as a whole may ultimately be more reliable. This is because the ferrule assembly may already come from the manufacturer pre-attached to the optical fiber. After running the pre-ferruled optical fiber as desired (e.g., blowing the pre-ferruled optical fiber through a conduit), the technician in the field may need merely to assembly the optical connector in the field so as to hold the ferrule assembly.

Thus, illustrative embodiments of a connector have been described that are practical for assembly in the field, such as by the end user. The described connector may be easier, faster, and cheaper to assemble than creating a conventional fusion splice, and/or more reliable than a conventional mechanical splice. Although the embodiments shown in the drawings are illustratively directed to a SC-P type optical connector that optically connects to another SC-P type optical connector such as connector 103, aspects of the invention as described herein apply to other types of optical connectors, with minor modifications for doing so being readily apparent to one of ordinary skill in the relevant art after having the benefit of reading the present disclosure.

What is claimed is:

1. An optical connector at an end of an optical fiber, comprising:
a first component having a first channel therein;
a second component having a second channel therein, wherein the second component is configured to physically mate with the first component such that the first and second channels merge to form a single continuous first channel extending completely through the mated first and second components;
a third component having a second channel configured to as to receive the mated first and second components; and
an optical fiber partially disposed within the second channel.

2. The optical connector of claim 1, further comprising:
a fourth component at least partially disposed within the second channel; and
a spring completely disposed within the second channel between (a) the mated first and second components and (b) the third fourth component.

3. The optical connector of claim 1, further comprising a ferrule assembly connected to the end of the optical fiber, the ferrule assembly being at least partially disposed within the first channel and the second channel.

4. The optical connector of claim 3, wherein the optical fiber is further partially disposed within the first channel.

5. The optical connector of claim 3, wherein the first channel has an inner shape, and the ferrule assembly has an outer shape, such that the ferrule assembly fits within the first channel only in a single rotational orientation relative to the first channel.

6. The optical connector of claim 3, wherein the first channel has an inner shape, and the ferrule assembly has an outer shape, such that the ferrule assembly fits within the first channel only in two rotational orientations relative to the first channel.

7. The optical connector of claim 1, wherein the optical connector is configured as a SC-P type optical connector.

8. A kit, comprising:
a first component having an open first channel therein;
a second component having an open second channel therein;
a third component having a third channel therein;
a fourth component having a fourth channel therein of a diameter sufficient to simultaneously enclose at least a portion of each of the first component, the second component, and the third component;
an optical fiber; and
a ferrule connected to an end of the optical fiber; and

9. The kit of claim 8, wherein the first component and the second component are connected together to form a component such that the first channel and the second channel combine to form a fifth channel, and wherein the ferrule is configured so as to fit within the fifth channel.

10. The kit of claim 8, wherein the first component and the second component are configured to be connectable together such that the first channel and the second channel combine to form a fifth channel, and wherein first component, the second component, and the ferrule are configured such that the ferrule fits within the fifth channel.

11. The kit of claim 10, wherein the first component, the second component, and the ferrule are further configured such that the ferrule fits within the fifth channel in only one rotational orientation relative to the fifth channel.

12. The kit of claim 10, wherein the first component, the second component, and the ferrule are further configured such that the ferrule fits within the fifth channel in only two rotational orientations relative to the fifth channel.

14. The kit of claim 8, further comprising a spring, wherein the diameter of the fourth channel is sufficient to simultaneously enclose at least a portion of each of the first component, the second component, the third component, and the spring.

15. The kit of claim 8, further comprising a set of written instructions describing how the ferrule, the first component, the second component, the third component, and the fourth component are assembled together.

16. A method of assembling an optical connector, comprising:
disposing a ferrule within a first channel of a first component such that the ferrule and the second component are rotationally fixed with respect to each other, the ferrule being connected to an optical fiber;
disposing the first component within a channel of a second component while the ferrule remains within the first channel, such that the first component and the second component are rotationally fixed with respect to each other; and
disposing the second component within a channel of a third component while the ferrule remains within the first channel and while the first component remains in the second component, such that the second component and the third component are rotationally fixed with respect to each other.

17. The method of claim 16, further comprising connecting a first member having a first open channel and a second member having a second open channel together to form the first component, such that the first and second open channels together form the first channel of the first component.

18. The method of claim 16, further comprising:
inserting the ferrule and the optical fiber through a spring; and
after inserting, disposing the spring inside the second channel.

19. The method of claim 16, wherein the first, second, and third channels are co-axial.

20. The method of claim 16, wherein the ferrule has one of a depression and a protrusion and the first channel has the other of a depression and a protrusion, and wherein disposing the ferrule within the first channel includes aligning the ferrule and the first component with each other such that the protrusion fits within the depression.
